(19) United States
(12) Patent Application Publication
(10) Pub. No.: US 2023/0297055 A1
(43) Pub. Date: Sep. 21, 2023

(54) Extension module with tamper protection

(71) Applicant: VEGA GRIESHABER KG, Wolfach (DE)

(72) Inventor: Roland Welle, Wolfach (DE)

(21) Appl. No.: 17/919,680

(22) PCT Filed: May 5, 2020
(86) PCT No.: PCT/EP2020/062430

§ 371 Date: Oct. 18, 2022

(51) Int. Cl. G05B 19/042

(52) U.S. Cl. CPC G05B 19/0425; G05B 2219/25428

(57) ABSTRACT

A field device with field device electronics and at least one extension module, characterized in that the field device electronics and/or the field device is persistently connected to at least one extension module.

### CROSS REFERENCE TO RELATED APPLICATIONS

This patent application claims priority International Patent Application PCT/EP2020/062430, filed on May 5, 2020.

### STATEMENT REGARDING FEDERALLY SPONSORED RESEARCH OR DEVELOPMENT

No federal government funds were used in researching or developing this invention.

### NAMES OF PARTIES TO A JOINT RESEARCH AGREEMENT

Not applicable.

### SEQUENCE LISTING INCLUDED AND INCORPORATED BY REFERENCE HEREIN

Not applicable.

### BACKGROUND

### Field of the Invention

The invention is a field device with an extension module and related modular field device and method of operation.

### Background of the Invention

The Various types of field devices are known from the prior art.

The term field device covers various technical devices that are directly related to a production process. Field devices can thus be, in particular, actuators, sensors and measuring transducers and/or evaluation devices.

In the terminology used in this application, higher-level units that belong to the field of control rooms must be clearly distinguished from field devices.

Field devices have been reliably measuring process-relevant measured variables of media in a wide variety of applications as process measuring devices for many years. In the early years of process control technology, the measured values were usually transmitted in analog form using analog interfaces, for example a 4-20 mA interface, from a process measuring device to a higher-level unit, for example an evaluation device or a process control station. In the course of digitalization, this standard was extended by additional digital signals, for example according to the HART standard, whereby bidirectional communication between the process measuring device and the process control station became possible. However, a characteristic feature of such process control systems was that the plants were essentially operated in isolated mode. A connection between different process control systems of different locations or different companies or a connection of the systems to the World Wide Web was not planned.

Modular field devices, which are assembled from a modular field device concept, are also known from the prior art. In a modular field device concept, it is possible to select from a number of combinable sensors, housings, electronic units or electronic modules and operating and/or display units, each of which is matched to the other, and to construct a corresponding field device. Such a modular field device concept is offered, for example, by Vega Grieshaber KG. Usually, a sensor, a corresponding electronic module containing the field device electronics, i.e. in particular a measured value processing unit and an interface to a controller and, if applicable, a field bus used, as well as various display and/or operating units can be combined. The sensors, electronic modules and display and/or operating units are adapted to each other as well as to different available housings.

Known field devices for process automation have so far only had manufacturer-specific defined devices and procedures for implementing aspects of IT security. Recent legal requirements in various countries demand that predefined security levels (SL) be implemented for critical infrastructure facilities (CRITIS).

In recent years, especially with the approaches of the fourth industrial revolution (Industry 4.0), the need has emerged to link entire process control systems or even entire production sites with each other through a higher degree of networking, for example via the World Wide Web. However, the associated networking of industrial IT systems and office IT systems leads to a number of new challenges, especially in the area of IT security, which makes further development of existing devices and components absolutely necessary.

Another area of application is the recent availability of stand-alone field devices, in particular stand-alone sensors. Sensors, i.e. field devices of this product family, are characterized by a particularly simple installation without attaching a communication or supply line. The measured values determined by these field devices are typically transmitted to a cloud, i.e., to a server on the World Wide Web, using a narrowband radio technology (LoRa, Sigfox, NB-IOT). Typical application scenarios for such field devices include areas such as flood forecasting, inventory management, or other decentralized distributed measurement tasks. Due to the direct connection to the World Wide Web, such field devices are inherently exposed to a permanent threat of hacker attacks from the network.

Newer requirements for field devices aim to make them robust against sabotage attacks, as a result of which massive material and immaterial damage to buildings, plants, living beings and the environment could occur. Such sabotage attacks can occur through physical impact on site, or through hacking attacks from within a network, resulting in massive disruption. In addition, aspects relating to theft protection, explosion protection, confidentiality of internal wiring details may justify the need to prevent unauthorized disassembly of an extension module from a sensor.

Modular field devices are highly flexible in their application and configuration and can be adapted to a wide range of application scenarios. In this context, the problem arises that a predefined composition of a modular field device may not be changed without further ado, be it for reasons of special tuning or configuration for a monitored process, for reasons of IT security, to protect in-house know-how or for theft protection.

It is the object of the present invention to further design a modular field device, a modular field device concept, and a method for operating modular field devices in such a way that the emerging requirements are met while maintaining the flexibility of modularity.

This object is achieved by a field device with an extension module and the method of operation as described herein.

### BRIEF SUMMARY OF THE INVENTION

In a preferred embodiment, a field device (101, 502) having an electronics module (102) with field device electronics and at least an extension module (106, 201, 301, 501), characterized in that the electronics module (102) and/or the field device (101, 502) is persistently connected to at least one extension module (106, 201, 301, 501).

In a preferred embodiment, a field device (101, 502) as described herein, characterized in that the electronic module (102) and/or the field device (101, 502) is mechanically persistently connected to the extension module (106, 201, 301, 501).

In a preferred embodiment, a field device (101, 502) as described herein, characterized in that the electronic module (102) is electrically persistently connected to the extension module (106, 201, 301, 501).

In a preferred embodiment, a field device (101, 502) as described herein, characterized in that the electronic module (102) is logically persistently connected to the extension module (106, 201, 301, 501).

In a preferred embodiment, a field device (101, 502) as described herein, characterized in that the electronic module (102) has a unique device identification and/or the extension module (106, 201, 301, 501) has a unique module identification.

In a preferred embodiment, a field device (101, 502) as described herein, characterized in that the electronic module (102) has a unique device certificate and/or the extension module (106, 201, 301, 501) has a unique module certificate.

In a preferred embodiment, a field device (101, 502) as described herein, in that the field device (101, 502) is designed as a level, level limit, flow, density or density profile measuring device.

In a preferred embodiment, a field device (101, 502) as described herein, characterized in that the extension module (106, 201, 301, 501) is designed as a blocking module, preferably a mechanical blocking module.

In a preferred embodiment, a field device (101, 502) as described herein, characterized in that the extension module (106, 201, 301, 501) is designed as a display and/or operating module.

In a preferred embodiment, a field device (101, 502) as described herein, characterized in that the extension module (106, 201, 301, 501) comprises a safety module.

In a preferred embodiment, a field device (101, 502) as described herein, characterized in that the security module is suitably configured for implementing predetermined IT security levels.

In a preferred embodiment, a field device (101, 502) as described herein, characterized in that the electronic module (102) and/or the extension module (106, 201, 301, 501) is configured such that a loosening of the persistent connection triggers an error message.

In a preferred embodiment, a field device (101, 502) as described herein, characterized in that the extension module (106, 201, 301, 501) is formed as a separately manageable unit.

A modular field device comprising a plurality of different sensors (100), a plurality of different housings, a plurality of electronic modules (102) and a plurality of extension modules (106, 201, 301, 501), characterized in that at least one combination of housing and/or electronic module (102) and extension module (106, 201, 301, 501) is designed and matched to one another in such a way that the electronic module (102) and/or the housing can be persistently connected to at least one extension module (106, 201, 301, 501).

A method for operating a field device (101, 502) as described herein, with field device electronics and at least one extension module (106, 201, 301, 501), characterized in that the electronics module (102) and/or the field device (101, 502) is persistently connected to at least one extension module (106, 201, 301, 501).

A method of operating a field device as described herein, characterized in that the electronics module (102) and/or the field device (101, 502) is mechanically persistently connected to the extension module (106, 201, 301, 501) and/or the field device electronics is electrically and/or logically persistently connected to the extension module (106, 201, 301, 501).

A method of operating a field device as described herein, characterized in that the electronic module (102) and/or the extension module (106, 201, 301, 501) is configured such that a release of the persistent connection triggers an error message.

### BRIEF DESCRIPTION OF THE DRAWINGS

FIG. 1 is a line drawing evidencing a field device according to the prior art,

FIG. 2 is a line drawing evidencing a first embodiment of a field device according to the present application,

FIG. 3 is a line drawing evidencing a second embodiment of a field device according to the present application,

FIG. 4 is a line drawing evidencing an example of a method for operating a field device according to FIG. 3 and

FIG. 5 is a line drawing evidencing a third embodiment of a field device with an extension module designed for this purpose.

### DETAILED DESCRIPTION OF THE INVENTION

A field device according to the invention comprising an electronic module with field device electronics and at least one extension module is characterized in that the electronic module and/or the field device is persistently connected to at least one extension module.

The field device according to the invention has a modular structure with at least one electronics module with the field device electronics and at least one extension module, wherein the field device electronics, which for simplicity is also referred to as the electronics module, is persistently connected to the at least one extension module.

Persistent in this context means “not uncontrollably changeable”, which means in particular that a change is either prevented or at least made more difficult and registered.

In the present case, persistently connecting the electronics module and/or the field device and the extension module means that the field device electronics and the extension module and/or the field device and the extension module cannot be separated from each other in an uncontrolled manner. This ensures that once a configuration of electronics module and extension module has been established, it cannot be changed, or at least not unnoticed. This protects the predetermined configuration from unauthorized changes and ensures that no unauthorized interventions are made.

A persistent connection can be established, for example, by the electronic module and/or the field device being mechanically persistently connected to the extension module.

In a first embodiment, a mechanically persistent connection can be achieved by mechanically locking the extension module to the electronic module and/or in a housing of the field device, for example by suitably arranged locking latches. Additionally or alternatively, a mechanically persistent connection can be achieved by a bonding, for example by an adhesive ring, which bonds to the electronic module and/or the housing of the field device when the extension module is completely and correctly mounted. A mechanically persistent, i.e. irreversible, connection can, for example, be designed as an irreversible snap-in connection and/or an irreversible screw connection and/or an irreversible adhesive connection and/or comprise an irreversible barrier.

An irreversible barrier can be, for example, a housing lid that irreversibly closes a housing chamber in which the extension module is located. For this purpose, an original housing cover can be exchanged and replaced with a self-locking cover. A self-locking lid can, for example, have latching hooks or the like that prevent the lid from opening after it has been completely closed for the first time. Additionally or alternatively, the self-locking lid can have a bonding that fixes the lid in a screwed position.

Both installation of the extension module in accordance with regulations and possible unauthorized removal can be monitored by means of corresponding contact switches. Such a sabotage contact would then report to the higher-level unit when the extension module has been unlawfully removed or tampered with. The unlawful interference is thus detected and countermeasures can be taken.

In a further embodiment, the electronic module is electrically persistently connected to the extension module. In one variant, an electrically persistent connection can be achieved by a persistent design of an electrical connection between the field device electronics in the electronics module and the extension module. For example, electrical connectors, in particular plug connectors, can be designed with a mechanically irreversible interlock. This means, for example, that the connectors cannot be released non-destructively. In addition or alternatively, the electrical connection between the field device electronics and the extension module can be designed to be inaccessible from the outside and thus tamper-proof.

In this embodiment, the extension module can also be functionless and only permanently close off physical access to electrical contacts of the field device electronics. In this way, different extension stages of a field device can be offered with one and the same electronic module with identical field device electronics, whereby, for example, in a more favorable extension stage, the connection of functional extension modules is permanently prevented by the functionless extension module. By using identical field device electronics, higher quantities and thus lower costs can be realized in production.

Additionally or alternatively, continuous monitoring of the electrical connections between the field device electronics and the extension module can also be implemented by means of a firmware update. An unauthorized interruption of a connection can lead to an alarm signal and/or a shutdown of the field device and/or a blocking of access to the configuration of the field device.

In a further embodiment, the field device electronics are logically persistently connected to the extension module. A logically persistent connection means a link between the field device electronics and the extension module by means of a unique identification.

For example, the field device electronics and thus the electronic module can have a unique device identification and/or the extension module can have a unique module identification. The respective identification of the other module, can be stored in an inaccessible memory area and thus alternately checked whether the correct module is connected.

In addition or alternatively, the field device electronics can have a unique device certificate and/or the extension module can have a unique module certificate. These certificates can also be exchanged, thus logically securing the original configuration.

The certificates can also be used to encrypt the communication between the modules.

Corresponding checksums can also be used to determine whether a stored device identification or certificate has been modified. If this is the case, the procedure can be followed as described above with regard to an unauthorized interruption of the electrical connection.

The field device is preferably designed as a field device of process automation, preferably as a level, level limit, flow, density or density profile measuring device.

The extension module can be designed as a blocking module, preferably a mechanical blocking module, as described above. Such a blocking module can prevent mechanical access to electrical contacts or prevent removal of the field device electronics from the housing of the field device.

Alternatively, the extension module can be designed as a display and/or operating module.

The extension module may further comprise a security module. Such a security module can implement various functions and, in particular, be suitably designed for implementing predefined IT security levels.

In order to ensure the availability of productive systems in the future, standards are currently being defined by various industries with the aim of hardening the components of process control systems in terms of their resilience to negligently or deliberately initiated external attacks and thus increasing the availability of field devices and securing the productivity of plant operators.

In addition, new requirements are being formulated by legislators for operators and manufacturers of equipment with the aim of making critical infrastructure facilities (CRITIS) such as energy (electricity, gas, oil), transport (air, rail, water, road), drinking water supplies and digital infrastructure resistant to negligent or deliberate hacker attacks. An example of this is Directive 2016/1148 (NIS Directive) adopted by the European Parliament, which has since been transposed into national law by the member states of the European Union.

Depending on the threat situation at the respective application site, the cyber security standards that have existed to date (e.g., IEC 62443, ISO 27001) require that the devices used there meet a standardized IT security level, also known as security level (SL).

IEC 62443 (Status_08/2013 for example), has defined the following security levels for this purpose, which are classified according to the means available to the attacker, available material and financial resources, technical capabilities, and underlying motivation.

Skills of the attacker

| | | | | |
|---|---|---|---|---|
| | Medium | Resources | Skills | Motivation |
| SL0 | No risk of interference / manipulation | | | |
| SL1 | accidental / incidental interference / manipulation | | | |
| SL2 | simply | limited | general | low |
| SL3 | sophisticated | medium | domain-specific | medium |
| SL4 | sophisticated | extensive | domain-specific | high |

Security level SL0 is a purely theoretical construct in which there is no risk of compromise or manipulation and therefore no measures are necessary.

The SL1 security level describes the ability of a system to prevent accidental and unintentional interference or tampering.

The SL2 security level describes the ability of a system to resist intentional manipulation by interested individuals and companies with generic security knowledge.

The SL3 security level describes the ability of a system to fend off intentional manipulation by experts and companies that develop and deploy effective, yet cost-oriented attack scenarios with clear goals.

The SL4 security level describes the ability of a system to repel intentional manipulation by organizations with experts focused on achieving the specifically selected attack target at almost any cost.

For the manufacturers of field devices, in particular also for the manufacturers of level and pressure sensors, these framework conditions result in the necessity to implement the IT security specifications anchored in various (industry-specific) standards and laws.

This implementation of extended measures regularly makes it necessary to integrate additional hardware components and/or additional software components into the field devices. If compliance with a security level (SL) is required for existing devices, or if the requirements for obtaining certification for a defined security level (SL) change, this regularly leads to having to revise the mechanical and electrical design of such devices. Devices already delivered must then be replaced by the customer with the correspondingly certified successor devices, which leads to corresponding costs and maintenance effort.

There is also the problem that industry-specific standards with the IT security levels SL defined in each case must be taken into account technically. In addition, the different regulations on the part of the legislator must be taken into account.

Furthermore, on the part of the manufacturers, there is the problem that devices must be developed, manufactured and distributed for different safety standards and different safety levels (SL), possibly also in accordance with the different standards in different countries.

These requirements can be well met by the manufacturer with an extension module that can be combined with the field device electronics depending on the required IT security level.

This makes it possible to equip or provide both new devices and existing devices with different IT security levels by means of a number of different extension modules, without it being necessary to provide a completely new device that implements the respective IT security level. For manufacturers, this makes it easier to offer adapted field devices, although a basic device remains identical and is only supplemented by the corresponding extension module. For users or operators of existing devices, this opens up the possibility of adapting their existing devices to changed IT security requirements without having to replace the respective existing devices. The existing devices are retrofitted with an extension module that implements the desired IT security level and thus upgraded for operation under increased IT security requirements.

The extension module can have a plurality of functional units for implementing the specified IT security level. In this way, several different extension modules with different functional units can be provided that implement different IT security levels in interaction with a field device.

Alternatively, an extension module can be designed in such a way that it can implement several different IT security levels in interaction with a field device. In this context, this means that at least two different IT security levels can be implemented by at least two functional units. Depending on the given requirements, individual functional units that are not required or not permitted for implementing a particular IT security level can then be deactivated or required or prescribed functional units can be activated, so that several different IT security levels can be implemented with one extension module.

In the present application, functional units are understood to mean functional blocks implemented in hardware and/or software which are decisive for compliance with the specified IT security levels. In particular, IT security levels of different levels usually differ at least in one functional unit, i.e. at least one functional unit is activated or deactivated for the implementation of one IT security level, which is correspondingly not activated or deactivated for the implementation of another IT security level.

The IT security levels underlying this application can address different aspects of IT security and can be implemented through different measures summarized in the functional units in this application.

Aspects of IT security that may be implemented in the IT security levels covered by the application include various levels of identification and authentication of users, devices and software, usage control, protection of the communication of the field device with regard to authentication and integrity, and, for example, required response times.

For this purpose, the upgrade module can have a first electrical interface for connecting the electronics module of the level meter and a communication module for connecting to a higher-level unit. By means of the first electrical interface, the extension module can be connected to the field device electronics, preferably a communication interface, more preferably a wired communication interface of the field device electronics. With the communication module, the upgrade module can establish communication to the outside. In this sense, outward means to a unit outside the field device, in particular a higher-level unit, an operating device or other field devices.

In this context, superordinate units can be evaluation devices and computers in a control room, for example, or servers in a LAN (local area network) or WAN (wide area network) environment. Devices in virtual private networks (VPN) are also covered by this.

In one embodiment, the field device electronics and/or the extension module can be designed in such a way that a loosening of the persistent connection triggers an error message. This can be done either by monitoring electrical connections, as described above, or by contact switches, so-called sabotage contacts, as also described above.

In particular, it should be emphasized at this point that the extension module is designed as a separately manageable unit. This means that the extension module is designed as part of a modular system of different, coordinated modules and as a separate construction unit.

A modular field device concept according to the invention comprising a plurality of different sensors, a plurality of different housings, a plurality of electronic modules and a plurality of extension modules is characterized in that at least one combination of housing and/or electronic module and extension module is designed and matched to each other in such a way that the electronic module and/or the housing can be persistently connected to at least one extension module.

A method according to the invention for operating a field device with an electronics module with field device electronics and at least one extension module is characterized by the fact that the field device electronics and/or the field device is persistently connected to at least one extension module. When the field device is set up or commissioned for the first time, the extension module is therefore permanently connected to the field device electronics, i.e. the electronics module, and/or the field device or its housing.

The electronic module and/or the field device is preferably mechanically persistently connected to the extension module and/or the field device electronics is electrically and/or logically persistently connected to the extension module. In this way, unauthorized disconnection is prevented.

Preferably, the field device electronics and/or the extension module is designed in such a way that a loosening of the persistent connection triggers an error message.

In this way, unnoticed disconnection is prevented.

### DETAILED DESCRIPTION OF THE FIGURES

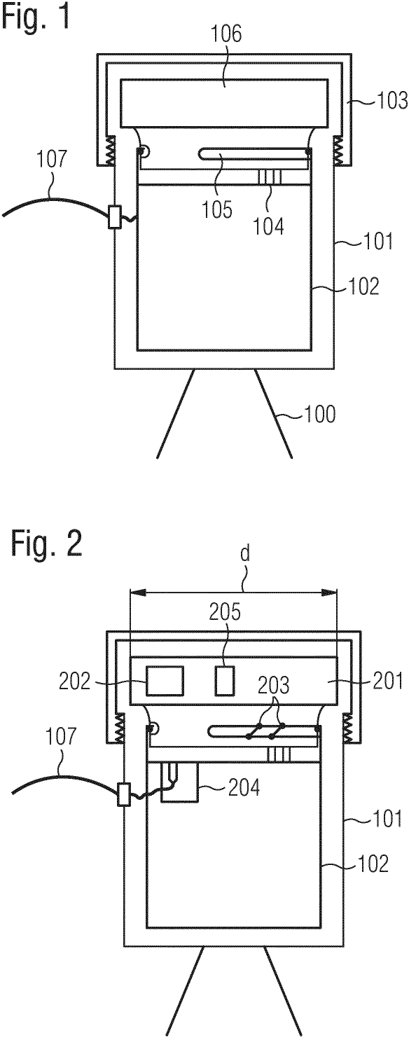

FIG. 1 shows a field device according to the prior art.

In the present embodiment, the field device 101 is designed as a radar level meter. The field device 101 has as sensor 100 a transmitting and receiving device with a horn antenna. In a housing of the field device 101, an electronic module 102 with an electronic unit adapted to the sensor 100 is arranged, which has an electronic extension interface 104.

Various extension modules can be connected to this extension interface 104 and mounted in the field device 101 by the end customer himself. It is particularly common to extend existing sensors 101 with an extension module 106, which is designed as a display and operating unit. The extension module 106 exchanges both power and data with the field device electronics in the electronics module 102 via the electronic interface 104.

Mechanically, the extension module 106 is attached to the electronics module 102 by means of a standardized mechanical housing receptacle 105, for example a screw-in mechanism 105. A housing cover 103 protects the overall electronics unit consisting of electronics module 102 and extension module 106 from mechanical and atmospheric interference.

Previous extension modules 106 are generally designed to be mounted and dismounted any number of times on one or more different field devices 101.

Current requirements place increasing emphasis on preventing unauthorized access to a field device 101 or attempted sabotage to disrupt the field device 101 or, for example, a measurement process.

Previous solutions in the prior art provide for preventing unauthorized access by means of a PIN query in the extension module 106, which is designed as a display and operating module. However, this cannot prevent the extension module 106 and/or the electronics module 102 from being removed or manipulated on the hardware side during a sabotage. At worst, the entire field device 101 is disconnected from a supply line 107 and replaced by a dummy sensor which is connected to the supply line 107. The analog and/or digital measured values supplied by this dummy sensor can be manipulated as desired, so that complete production systems can be put out of operation.

FIG. 2 shows a first embodiment of a field device 101 according to the present application with an extension module 201, which in the present case is configured as a safety module.

The security module 201 contains various hardware and software units that are required to implement a defined security level (SL) in interaction with the field device electronics in the electronics module 102. In the present embodiment, the security module 201 includes, in particular, a user administration 202, which contains a list of authorized users for enabling configuration of the field device 101. To ensure the security concept, i.e. to ensure that the IT security level (SL) is not changed, it may be necessary to prevent disassembly of the security module 201 from now on, so that uncontrolled access to the field device 101 cannot be realized with existing modules 106. To this end, the safety module 201 has a mechanically persistent connection to the electronic module 102, which in the present embodiment is implemented by a cascade of flexible locking latches 203, which are pushed aside when the safety module 201 is installed on the electronic module 102, but which lay crosswise when an attempt is made to remove the safety module 201 and hook in such a way that disassembly is prevented.

Furthermore, an electrical persistence can be achieved by a corresponding design of the mechanical dimensions of the safety module 201. For this purpose, in addition to the module 201 shown, functionless modules can also be used in particular, which are used exclusively for irreversible mechanical sealing.

In the embodiment shown in FIG. 2, after the extension module 201 has been inserted once, mechanical access to electrical contacts 204 of the electronics module 102 is permanently prevented due to a diameter d of a module housing. As a result, unauthorized disconnection of the connection between an electrical lead 107 and the sensor electronics in the electronics module 102 can be prevented from now on.

Complementarily, by importing a new firmware 205 into the electronic module 102, the behavior of the field device 101 is changed such that continuous monitoring of the currents in the supply line 107 is realized. In case of an unintended interruption, the operation of the field device 101 is interrupted after a restart following the output of a fault message. Furthermore, when an interruption is detected, a final alarm signal, for example fed from an energy storage device not shown here, is transmitted wirelessly to a higher-level unit.

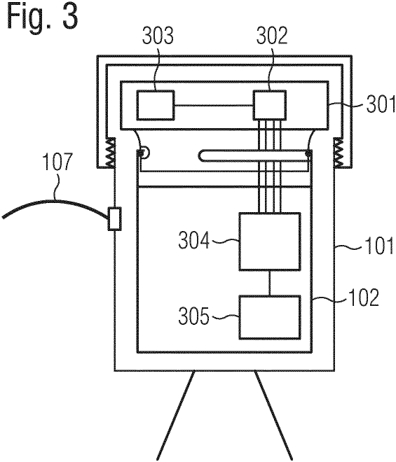

FIG. 3 shows a second embodiment of a field device 101 according to the present application.

In the embodiment shown in FIG. 3, the extension module 301 used therein is logically sealed to provide logical persistence thereto. The extension module 301 can be mechanically assembled and subsequently disassembled from the electronics module 102 any number of times. However, during the first mounting of the extension module 301, the interaction of the components 302, 303, 304, 305 achieves that the extension module 301 and the electronic module 102 are logically linked to each other in such a way that a further operation of the field device without the extension module 301 and/or a mounting of the extension module 301 on another field device is henceforth no longer possible.

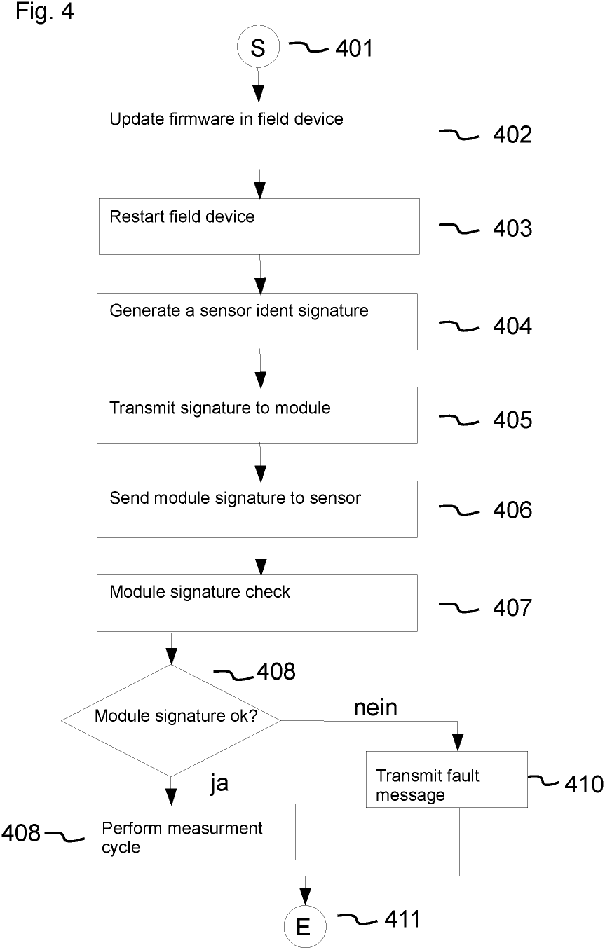

The procedure for this is shown in detail in the flow chart in FIG. 4.

The method begins by plugging in the extension module 301 in step 401. First, in step 402, the extension module 301 updates the firmware of the field device 101 by copying the firmware to the electronics module 102. To do this, a first processor 302 in the extension module 301 transmits the information stored in a non-volatile memory 303 to a processor 304 in the electronics module 102, which then updates the program code 305.

In step 403, the field device 101 is restarted, and according to the instructions of the program code now new due to the firmware update, instructed in step 404 to generate a unique sensor ident signature, such as a numeric code.

The code is transmitted to the extension module 301 in step 405, whereupon the extension module stores this signature in the non-volatile memory 303. Henceforth, the extension module 301 will start its operation only in interaction with the electronic module 102 whose signature matches the signature stored in the memory 303.

In step 406, the extension module 301 sends its own secret signature, for example one generated at the factory, back to the electronic module 102. In the processor 304 of the electronic module 102, this signature is now checked, and here in particular compared with the signature of an accepted module transmitted by the software update.

If the comparison is successful, step 409 activates the normal operating mode of the field device 101 to determine a measurement value.

Otherwise, in step 410, a fault message is transmitted wired or wirelessly to the outside world, and regular sensor operation is denied. The procedure ends in step 411.

By means of the method presented above, it can be achieved that the electronic module 102 and the extension module 301 can henceforth only be operated together in exactly this combination, and are consequently logically uniquely coupled to each other. The extension module 301 may therefore be considered logically persistent in the context of the present invention.

The embodiment of an extension module with logical persistence shown in FIG. 3 and FIG. 4 can be used advantageously in the context of proposed extension modules for obtaining a security function (SL). In addition, however, aspects relating to theft protection, explosion protection or the confidentiality of internal wiring details can also be implemented using the embodiments shown previously and in the following. Special embodiments can also be used to realize strategies for commercial marketing of field devices.

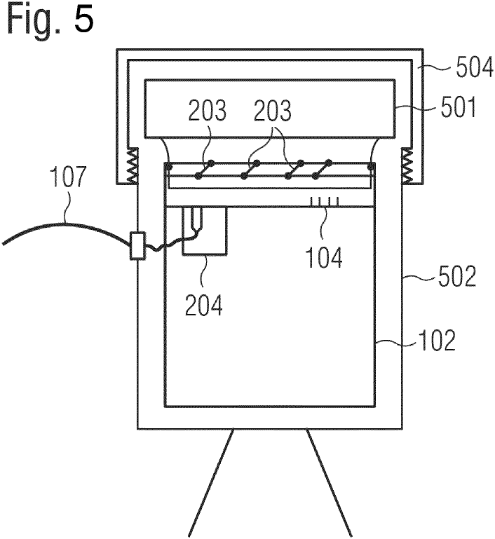

FIG. 5 shows a field device 502 with an extension module 501 designed for this purpose.

In the present embodiment, the extension module 501 has devices 203 that lead to the attainment of mechanical persistence of the extension module 501 after assembly has been completed. In the present embodiment, the extension module 501 is equipped as a so-called blocking module without additional functions, and also has no connection to the extension interface 104 of the electronic module 102. The embodiment shown can be used in particular to implement different variants of a field device with different market prices.

For example, the field device 502 is provided on the market as a low-cost sensor without the option of expandability. In order to be able to make the production of the electronic module 102 inexpensive, it can be provided to use the standardized sensor electronics, which are also used in expandable devices, also in the inexpensive version, but to prevent the expandability by a mechanical covering of the extension interface 104. This can be done in a simple manner by applying a mechanically persistent extension module with corresponding locking latches 203 already at the manufacturer.

To prevent forcible removal of the extension module 501, the mechanical interface between the extension module 501 and the electronic module 102 may be configured such that if the extension module 501 is forcibly removed against the resistance of the locking detents, a mechanical receptacle on the electronic module 102 side is damaged or destroyed such that attachment of a functional extension module after forcible removal of the locking module becomes impossible.

Provision may further be made to attach a connection cable 503 to a terminal block with electrical contacts 204 of the electronic module 102 already at the manufacturer, thus completely protecting the interior of the electronic module 102 from external tampering or unauthorized extension.

It may also be intended to prevent or restrict the expandability of existing field devices for certain countries or target markets in order not to infringe existing third-party property rights in these countries. It may also be provided to ensure approval-relevant configurations, for example a flameproof enclosure of the field device 502 relevant for explosion protection, in an unchangeable manner by suitable persistent add-on modules. In one embodiment, the extension module 501 can also be designed in the form of a persistent housing cover 504, which can be bonded to the housing of the field device 502, for example.

In an exemplary embodiment, the module 501 exhibits mechanical persistence. However, it may be additionally or alternatively provided to use electrical and/or logical persistence to achieve the above objectives.

List of reference numbers:

| | |
|---|---|
| 100 | Sensor |
| 101, 502 | Field device |
| 102 | Electronics module |
| 103, 504 | Housing cover |
| 104 | Extension interface |
| 105 | Housing mount |
| 106, 201, 301, 501 | Extension module |
| 107 | Supply line |
| 202 | User management |
| 203 | Locking catches |
| 204 | Electrical contacts |
| 205 | Firmware |
| 302, 303, 304,305 | Components |
| 401 - 411 | Steps 1 - 11 |
| 503 | Connection cable |

Unless indicated otherwise, identical reference numbers in the figures identify identical components with the same function. The terms drive unit and drive are used interchangeably herein.

The references recited herein are incorporated herein in their entirety, particularly as they relate to teaching the level of ordinary skill in this art and for any disclosure necessary for the commoner understanding of the subject matter of the claimed invention. It will be clear to a person of ordinary skill in the art that the above embodiments may be altered or that insubstantial changes may be made without departing from the scope of the invention. Accordingly, the scope of the invention is determined by the scope of the following claims and their equitable equivalents.

We claim:

1. A field device having an electronics module with field device electronics and at least an extension module, whereas the electronics module and/or the field device is persistently connected to at least one extension module.

2. The field device according to claim 1, characterized in that the electronic module and/or the field device is mechanically persistently connected to the extension module.

3. The field device according to claim 1, wherein the electronic module is electrically persistently connected to the extension module.

4. The field device according to claim 1, wherein the electronic module is logically persistently connected to the extension module.

5. The field device according to claim 4, wherein the electronic module has a unique device identification and/or the extension module has a unique module identification.

6. Thefield device according to claim 4, wherein the electronic module has a unique device certificate and/or the extension module has a unique module certificate.

7. The field device according to claim 1, wherein the field device is designed as a level, level limit, flow, density or density profile measuring device.

8. The field device according to claim 1, wherein the extension module is designed as a blocking module, preferably a mechanical blocking module.

9. The field device according to claim 1, wherein the extension module is designed as a display and/or operating module.

10. The field device according to claim 1, whereas the extension module comprises a safety module.

11. The field device according to the security module is suitably configured claim 1, wherein for implementing predetermined IT security levels.

12. The field device according to claim 1, wherein the electronic module and/or the extension module is configured such that a loosening of the persistent connection triggers an error message.

13. The field device according to claim 1, wherein the extension module is formed as a separately manageable unit.

14. A modular field device concept comprising a plurality of different sensors, a plurality of different housings, a plurality of electronic modules and a plurality of extension modules, wherein at least one combination of housing and/or electronic module and extension module is designed and matched to one another in such a way that the electronic module and/or the housing can be persistently connected to at least one extension.

15. A method for operating a field device with field device electronics and at least one extension module, whereas the electronics module and/or the field device is persistently connected to at least one extension module.

16. The method accoriding to claim 15, whereas the electronics module and/or the field device is mechanically persistently connected to the extension module and/or the field device electronics is electrically and/or logically persistently connected to the extension.

17. The method for operating a field device accoding to claim 15, wherein the electronic module and/or the extension module is configured such that a release of the persistent connection triggers an error message.
